(19) United States
(12) Patent Application Publication
(10) Pub. No.: US 2010/0153175 A1
(43) Pub. Date: Jun. 17, 2010

(54) Correlation of Psycho-Demographic Data and Social Network Data to Initiate an Action

(75) Inventors: Larry B. Pearson, San Antonio, TX (US); Randolph Wohlert, Austin, TX (US)

Correspondence Address: AT&T Legal Department - GT;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/334,172

(22) Filed: Dec. 12, 2008

(51) Int. Cl. G06Q 99/00; G06Q 10/00; H04M 11/00

(52) U.S. Cl. 705/10; 379/88.14; 705/319

(57) ABSTRACT

An action is initiated based on data collected from a social network of a user. User data is collected automatically from activity of the user. Social data is collected from the user's social network. The social data includes information obtained from the activity of at least one second or greater order indirect member of the social network relative to the user. The user data, social data, and the psycho-demographic data are correlated to initiate the action.

### FIELD

At least some embodiments disclosed herein relate to computer information systems in general, and more particular but not limited to, correlation of psycho-demographic data and social data collected from a social network to initiate an action.

### BACKGROUND

The Internet provides a convenient way for a user to access information. People can further use the Internet to communicate with each other, share information, and organize virtual communities.

Existing social network websites are typically a social structure in which a network of nodes can be used to represent a network of members, such as individuals or organizations, and the connections between the nodes in the network represent the direct social connections. The web site can be used to register the social connections of the members of a social network and provide features such as automatic address book updates, viewable profiles, services to introduce members to each other to make new social connections, etc. Some Internet social networks are organized around business connections, and some Internet social networks are organized around common interests.

### BRIEF DESCRIPTION OF THE DRAWINGS

The embodiments are illustrated by way of example and not limitation in the figures of the accompanying drawings in which like references indicate similar elements.

FIG. 1 shows a system to collect and correlate user data and social network information according to one embodiment.

FIG. 2 shows a block diagram of a data processing system which can be used in various embodiments.

FIG. 3 shows a block diagram of a user device according to one embodiment.

FIG. 4 shows a method to collect and correlate user data and social network information according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” or similar means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, “activity” means any online or electronic activity for which electronic data may be collected or obtained, any offline activity from which data may be determined by any electronic, biometric, surveillance or other systems, and/or any file, database, or source of electronic information or data (e.g., files previously created by a person such as a user's address book or directory, calendar, or from a user's operation of an application such as application files). Activity includes, for example, Internet usage and communications (e.g., web browsing, instant messaging, and chat), cable communications, digital communications, telephone and cellular phone calls or other communications, any oral or visual or text communications made from any personal or mobile device, mobile and fixed telephone usage, video telephony, email, location and proximity, presence, television viewing choices, history or viewer comments or feedback, security/monitoring systems and services, and/or data from or activity associated with any telemetry or other system that captures participant-related location, proximity, activities, behaviors, or biometric-type data.

As used herein, “user data” means information associated with a user and includes, for example, information provided by the user and information obtained automatically from observation or other data collection from one or more sources of activity by the user. For example, user data from a user's activity may include call records (called and calling info), messaging (content and destinations), television viewing history, Internet browsing/search history, mobility information (e.g., geographic history), and user purchasing information.

As used herein, “social data” means data associated with members of a social network and includes, for example, information obtained from observations or other data collections from any activity of one or more members of a social network. The members may be, for example, a friend of a user of the social network and/or an indirect member of the social network relative to the user. The social network may be a social network website, or may be a social network as determined by other relationships (e.g., relationships determined from call history or email communications logs of a person or user and the persons called and/or emailed by the person).

As used herein, “correlating,” or one of its cognate words, means to identify or analyze a relationship, association, covariance, pattern, or correlation between two sets of data or information.

As used herein, an “action” means any action, activity, event, command, or providing of information involving an electronic, communications, or computing device, machine, or system (e.g., the sending of data to another computing device or system, or the presenting of information for use by, or display to, a user). Examples of an action may include using correlated information as a component of a demographic study, transmitting data to an advertising agency, and sending data to a traffic engineering system for prediction of congestion and dynamic adjustment or configuration of a traffic control network.

For example, results from an information correlation may show the sending of a very large number of soccer social network text messages from a championship game during soccer finals. A social network may be determined and used to predict a burst of network traffic expected during an upcoming next game in the finals (e.g., time and routes of text messages), and an action in the form of a command may be sent to the network to allocate and/or reserve additional network capacity for this upcoming soccer game.

As used herein, “psycho-demographic data” means demographic data that includes objective information and at least some subjective information regarding one or more subjective interests of one or more persons. For example, data regarding interests for individuals with similar psycho-demographic profiles may be aggregated along with data regarding interests for the user's social network, or a separate, collective aggregation of psycho-demographic interests may be maintained. Examples of subjective interests may include a person's favorite color, food, or type of restaurant.

As used herein, a “friend” means a person or entity having an existing or previous relationship to a user. The friend may be, for example, identified explicitly by the user (e.g., stated preferences, surveys, etc.), or may be implicitly determined from communication patterns of the user (e.g., text message or telephone records as to persons contacted, which persons would be considered to be friends of the user, etc.), or from user-entered application data (e.g., naming of friends to a friends list in an online social network, address books, and calendars). In an alternative embodiment, a friend may a person or entity having a relationship to the user that is geographic, in that persons or entities in the common proximity (e.g., within 50 feet) of the user may be considered friends of the user (e.g., location may be determined by GPS receivers in user mobile devices). The criteria used to determine a friend may be varied for any given embodiment or situation (e.g., the user may customize the criteria used to define a friend for any given embodiment through interaction with a user interface on a user mobile device).

As used herein, a “second or greater order indirect member” means a person or entity in a social network that is related to a friend of a user (e.g., a friend of the user's friend, which the user does not interact with directly in the social network, is a second order member of the social network). As another example, a third order member is a friend of a second order member and so on for higher orders.

Internet-based content has become a major source of information and entertainment for users. An extremely large amount of content is available and globally expanding rapidly. Attempts by a user to search the Internet for information and entertainment that is relevant to the user's interests are becoming increasingly ineffective due to user information overload, the need for the user to repeatedly perform individual searches on different topics of interest, and the time-consuming user task of filtering the search results.

Existing methods for locating relevant or personally-interesting information on the Internet are inefficient, inadequate, and often frustrating for users. Currently, a user typically obtains information of interest to the user by using search engines to look for content based on a given topic or through keyword searches, or by visiting favorite web sites for information. The user must know what information he or she is seeking, be able to describe it with key words, use one or more search engines to find content, look through the search results to filter out unwanted search results, and/or browse multiple web sites looking for information. This process may be time-consuming, ineffective, and result in user frustration.

Systems and methods to initiate an action (e.g., presenting search or other information to a user) based on results from a correlation of psycho-demographic data and social data collected from a social network are described herein. Some embodiments are summarized here initially, then described in more detail below.

In one embodiment, a method for initiating an action based on data collected from a social network of a user, implemented in a data processing system, includes: collecting user data, wherein the user data comprises user-provided information and information obtained automatically from activity of the user; storing, in at least one memory, psycho-demographic data; collecting social data from the social network, wherein the social data comprises information obtained from activity of at least two members of the social network, the at least two members comprising at least one friend of the user and at least one second or greater order indirect member of the social network relative to the user; correlating, using at least one processor, the user data, the social data, and the psycho-demographic data; and initiating the action based on the correlating.

The disclosure includes methods and apparatuses which perform these methods, including data processing systems which perform these methods, and computer readable media containing instructions which when executed on data processing systems cause the systems to perform these methods. Other features will be apparent from the accompanying drawings and from the detailed description which follows.

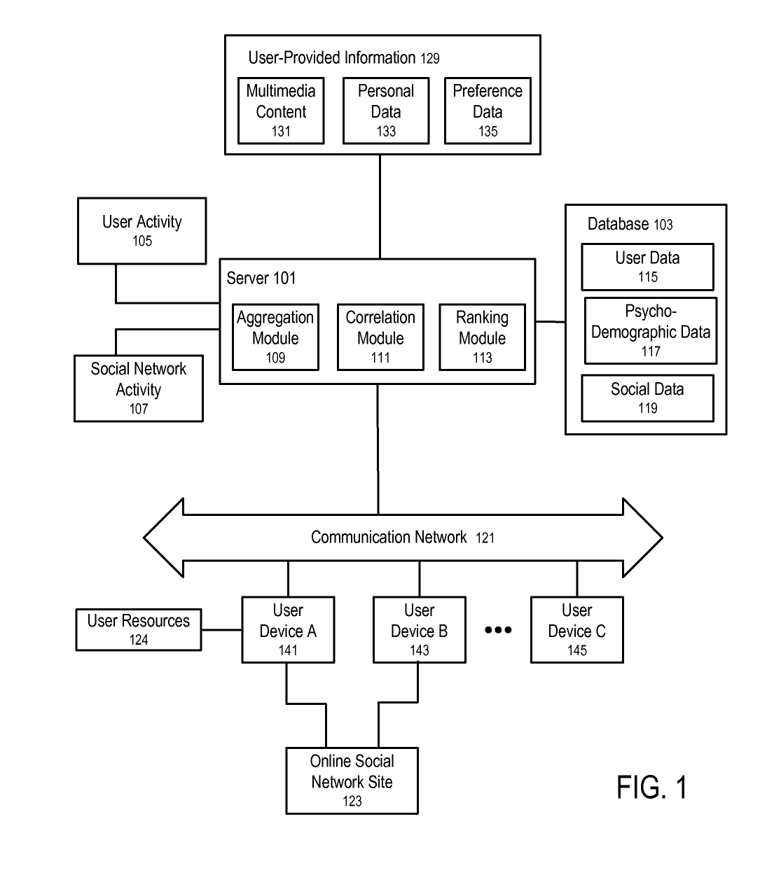

FIG. 1 shows a system to collect and correlate social network and other information according to one embodiment. In FIG. 1, user devices (e.g., 141, 143, . . . , 145) interact with server 101 over a communication network 121 (e.g., the Internet, wireless network, cable or satellite television communications system, cellular communications system, etc.).

User devices 141-145 may be, for example, cellular phones or email or other communication devices that send communications over communication network 121. Data is collected from these communications. Server 101 may receive portions of this data as user activity data 105 and/or social network activity data 107, which data is then aggregated and stored by aggregation module 109 in database 103. Server 101 may use this data to determine one or more social networks of a user as defined by criteria, for example, selected by the user in preference data 135, or as may be inferred from personal data 133. Also, for example, default criteria or criteria dynamically determined by rules stored in server 101 may be used to define the social network from which activity data will be analyzed by correlation module 111.

Server 101 is connected to a data storage facility (e.g., database 103) to receive and store user-provided information (129), such as multimedia content (131), personal data (133), preference data (135), etc. User-provided information 129 may be provided, for example, directly by a user (e.g., using user device 141), or indirectly from another server or service (not shown) that has previously obtained information 129 from a user and forwards information 129 to server 101.

In one embodiment, preference data 135 may include filter descriptors provided by the user to block potentially undesirable information from being tracked, shared, or rendered to the user or others (e.g., sexually explicit information). In another embodiment, server 101 may require the explicit consent (opt in) of the user (e.g., as stored in preference data 135), and the consent of the persons making up the user's social network from which data 107 will be collected.

As mentioned above, server 101 is connected to a database 103, which stores user data 115, psycho-demographic data 117, and social data 119. Server 101 may electronically receive psycho-demographic data 117 from, for example, one or more online marketing or other services. Data 117 may be updated automatically (e.g., periodically, such as every day). Data 117 may also be loaded manually to database 103.

In one embodiment, the psycho-demographic data 117 includes data from electronic commerce transactions for a group having a size greater than ten thousand persons. In another embodiment, the psycho-demographic data 117 includes data from search inquiries for a group having a size greater than ten thousand persons.

As mentioned above, server 101 receives user activity data 105 and social network activity data 107, to be stored in database 103. Data 105 and 107 may be obtained, for example, from various services (e.g., cellular or cable service) used by one or more users, and which is then forwarded from a server or other service (not shown) to server 101. The various services may be provided by the operator of server 101 or by a third party. For example, online social network site 123 may electronically transmit certain predefined social data to server 101. Similarly, social network site 123 and/or other sites (e.g., search engine sites) or services (e.g., text and other messaging service) may collect and forward user data 115 to server 101.

In other embodiments, social data 119 is formed, at least in part, from activity data 107 that is collected from a large volume of communications (e.g., cellular and email) by a large number of persons (e.g., the number of persons may be hundreds, thousands, or even millions or greater). Using this social data 119, server 101 can determine one or more social networks of a given user based on the user's relationships to the social data 119. Correlation module 111 determines these relationships.

It should be noted that these social networks are not limited to existing forms of social networks now formalized by an end-user's active and direct participation in the social network as a closed community (e.g., all members of Facebook, or all members of MySpace). In these environments, end-users “declare” who their “friends” are. That is, end-users self identify first order friends. From this information, the social network's closed community is defined. In contrast, in these other embodiments, the social networks of a user are determined by the large volume of communications data collected and the correlation of this data to various aspects of the user (e.g., as determined by user-provided information 129 and/or user activity data 105). For example, the data collected may broadly include any telemetry data that includes user or participant-related location, proximity, activities, behaviors, or biometric-type data.

In these other embodiments, to some degree, by monitoring user (e.g., cellular service customer) behavior in communications networks, a larger scale social network may be determined. Note that there is no need for a membership or relationship to be defined or declared by the user in order for the activity of members of these social networks to be analyzed by correlation module 111.

One example of automatically defining a social network is by using telephone call history information to provide social network activity data 107. There is a social relationship between a user and everyone he or she calls or talks to via telephone.

The more activity on the phone, the closer (or stronger) the relationships are. This activity (e.g., time of call, number of calls, etc.) may be used by ranking module 113 to determine a relative interest index, for example, for each person that has been called by the user. Then, server 101 may initiate the action of presenting a predefined number of information elements or data for these persons called by the user, for example, when the user is launching a client application (e.g., to limit the information presented to the user).

The communications that are monitored in this way may be extended to email, instant messaging (IM), texting, web browsing/surfing, television viewing, address books, etc. By monitoring many communications channels and correlating that information to specific people, for example, using an address book or directory, a multi-dimensional view of the complex social relationships of a user may be created.

In one embodiment, the social networks and ranking information determined from monitoring and correlating of data from the above communications channels may be provided for use by third party applications (e.g., by providing an application programming interface (API) to expose the relative interest index information through a plug-in for a browser or other end-user application).

Server 101 includes an aggregation module 109 that collects and stores data in database 103, and a correlation module 111 that analyzes user-provided information 129, psycho-demographic data 117, user activity data 105, and social network activity data 107. Correlation module 111 may use, for example, pattern matching, covariance analysis, or one or more of many other existing data mining or relationship analysis approaches.

In one embodiment, an aggregate list of interests data may be compiled by aggregation module 109 from the observed behavior of one or more of the following: the user of a user device (e.g., user device 141), the user's friends, persons within an n^{th} order of the user's extended social network (e.g. extended social network), persons with a similar psycho-demographic profile (e.g., as determined by sharing at least one item of psycho-demographic data 117 in common), and persons with similar psycho-demographic profiles within an n^{th} order of the user's extended social network.

In one embodiment, the members of the social network for which activity is observed share at least one common relationship to user data 115. In another embodiment, the at least one common relationship includes geographic proximity. In yet another embodiment, the at least one common relationship comprises at least one of the following: a uniform resource locator, a contact name, a calendar date, an area code, and a text string.

In one embodiment, the social data 119 includes psycho-demographic information about two or more members of a social network being monitored. In another embodiment, the at least one second or greater order indirect member of the social network being monitored includes two or more members of the social network that have at least one item of psycho-demographic information in common.

Server 101 also may include ranking module 113 to determine a relative interest index or other ranking for information elements (e.g., links, advertising information, search results, etc.) that server 101 is able to select from for presentation to the user or other action that may be initiated.

An online social network site (123) may include one or more web servers (or other types of data communication servers) to communicate with the user devices (e.g., 141 and 143). In FIG. 1, the users may use the devices (e.g., 141, 143, . . . , 145) to make recommendations to online social network site 123.

In one embodiment, the user device (e.g., 141, 143, . . . , 145) submits multimedia content 131 to server 101. For example, in one embodiment, the user device includes a digital still picture camera, or a digital video camera. The user device can be used to create multimedia content or other information for sharing with friends in the online social network. In such an embodiment, the multimedia or other content can be tagged with various forms of data in an automated way (e.g., location data from a GPS receiver in the user device).

Alternatively, the multimedia content can be created using a separate device and loaded into the online social network using the user device (e.g., 141, 143, . . . , 145). The users may manually tag the multimedia content with various data.

Although FIG. 1 illustrates an exemplary system implemented in a client-server architecture, embodiments of the disclosure can be implemented in various alternative architectures. For example, the system can be implemented via a peer to peer network of the user devices, where the multimedia content and other data are shared via peer to peer communication connections.

In some embodiments, a combination of client-server architecture and peer to peer architecture can be used, in which one or more centralized servers (e.g., server 101) may be used to provide some of the information and/or services and the peer to peer network is used to provide other information and/or services. Thus, embodiments of disclosure are not limited to a particular architecture.

Various user resources 124 may be available to the user for which an action may be initiated (e.g., user of device 141). In one embodiment, sever 101 gathers electronic data regarding at least one resource 124 available to the user. Resource 124 may be, for example, one or more of the following: a mobility resource, a communication resource, a device resource, and a calendar availability. The initiation of the action based on the results from correlation module 111 may be based in part on the information regarding the at least one resource (e.g., whether the user has a mobility resource).

More specifically, server 101 may gather information regarding user resources 124 a user has available including, for example, mobility resources (e.g., ability to walk, run, bike, hike, etc.), availability of transportation resources (e.g., personally-owned vehicle, public transportation, etc.), availability of communication resources (e.g., high/low broadband access, mobile data, telephone, etc.), availability of devices (e.g., GPS-enabled mobile phone, game boxes, etc.), calendar availability of free or unscheduled time (e.g., opposite of having to go to work). In other embodiments, other resources may also be available to the user.

Preference data 135 may include various user preference criteria used to select the information to be presented to, or other actions taken for, a user. For example, user preference criteria may include a requirement that the provider of the recommendation is in a preference friend-list of the user (or within a predetermined first, second or greater order relative to the user) in the social network of network site 123, or of another social network site or service being used to collect social network activity data 107. The user preference criteria may include a requirement that a person in the preference friend-list of the user (or within a predetermined first, second or greater order relative to the user) has done an activity more than a predetermined number of times (e.g., used it more than 2-5 times, or is repeatedly used). The user preference criteria may also include a requirement that a person in the preference friend-list of the user (or within a predetermined first, second or greater order relative to the user) has done an activity a certain number of times (e.g., specify a frequency of activity).

In one embodiment, the user preference criteria are configurable, pluggable, and tunable by the user. For example, the user may select a set of criteria from a set of pre-defined criteria, or add a custom designed criterion, or adjust the parameters of the selected criteria. Thus, the users can configure the matching process to obtain desired information from friends or others in a social network.

In one embodiment, server 101 may automatically and dynamically update user activity data 105 and social network activity data 107. For example, each time the user performs an Internet information search or access, user data 115 may be updated in database 103. Each time a user communicates with a friend, the definition of the user's social network (e.g., the user's list of friends) may be updated so as to define the scope of the social network from which social network activity data 107 is to be collected.

In other embodiments, the data 105 and/or data 107 may be time stamped and removed as it ages, or may be treated with a reduced correlation weight by ranking module 113. An embodiment may also use a circular queue with a limited number of entries in which older data entries are overwritten by newer entries.

In one embodiment, the social network from which social network activity data 107 is collected may be further defined by the user input. For example, server 101 may present the user with a user interface to enable the user to view and edit his or her social network information. A social network definition that is based solely on the observed user's communication behavior may not be as accurate as one that is refined with user input.

For example, a user may have close friends that are geographically distant and with whom communication is infrequent. As another example, the user's communication information can be used to initialize server 101, and the user could then subsequently refine the definition of the social network to be observed. A user-friendly “wizard” system component may provide this functionality.

In one embodiment, correlating module 111 initiates the presenting of information to the user on, for example, a display (not shown) of user device 141. In one embodiment, the user is served advertisements of interest to the user (e.g., displayed to the user and/or provided as an audio voice, music, or sound). This activity may generate advertising revenue for the entity operating server 101.

In another embodiment, the recommendations or other information presented to the user can also be used to support assisted manual browsing and selection of points of information. The recommendations or other information can be, for example, used to generate a list of options for the user and/or to filter the list retrieved from a compiled database of information elements.

Correlating module 111 may initiate yet other actions.

In one embodiment, ranking module 113 calculates a relative interest index for each of several information elements available to server 101 for serving to the user (e.g., on user device 141). The elements to present are selected based on the relative interest index calculated for each information element. The relative interest index may be based, for example, on one or more of the following: the time duration of an activity, the frequency of an activity, the geographic location of a person or entity, and the timeliness of an activity.

As a more specific example, the relative interest index may be provided as a measure of the degree to which each interest is potentially appealing to the user, and may be derived from a variety of factors, including but not limited to the following:

a. the strength of the relationship between the user and the friend(s) with whom the interest is associated;

b. the degree of commonality (e.g., frequency, or a predetermined number of times) the interest exists among the user, friends, or others with a similar psycho-demographic profile;

c. the amount of time spent pursuing the interest (e.g., the time spent engaged in viewing, browsing, reading a particular website or participating in particular activities);

d. timeliness of the interest (e.g., newer interests may be more relevant than older interests);

e. the user's own behavior (e.g., the user having demonstrated a personal interest by the user's activity);

f. proximity/location (e.g., of the user, and/or of a member in the social network).

In one embodiment, the information that is selected for presentation or other action may include one or more of the aspects of the interest information. The information may be conveyed to the user in a variety of fashions and may include links to the information summaries or descriptions of the information, the actual information itself, or the physical locations of interest-based “hot-spots.”

The information may be arranged, for example, in a variety of fashions, including sorting by interest index (e.g., measure of potential interest), grouped by interest subject or topic, grouped by timeliness (e.g., newest first), or grouped by distance from current user location, or alternate locations.

The information may be, for example, presented with a look and feel customized for the user (e.g., based on personal data 133 and/or preference data 135) such as in a personal electronic magazine or newspaper format, or a map format. The information may be used, for example, as the basis for providing related information to the user including direct provision of content, lists of content, pointers to content, or directions to locations.

Alternative embodiments may include other applications for which automatic and dynamic identification of user interest related information (and/or initiation of other actions) is desirable. Examples include targeted advertising, video recommendations, book recommendations, etc. In one embodiment, server 101 may present a user with a personal web page of information, or links to information, that the user will find interesting without the user needing to search for such information (e.g., a user could be automatically provided with personalized “what's happening” information page(s) for a more enjoyable and relevant browsing experience).

Other embodiments may include the following applications: general interests, specific interests, current events, local events, television program recommendations, restaurant recommendations, entertainment recommendations, book recommendations, music recommendations, and news. Yet other embodiments may include the following applications: communication control as in call controls and SPAM filtering, routing to various “points of interest” (e.g., directions to multiple ordered physical locations, or a trip planner that offers items of interest to the user while traveling).

Data regarding interests of the user and/or others (e.g., friends, second order members of a social network, general population or other groups or classifications of people corresponding to psycho-demographic data 117) may be indicated or expressed by various identifiers including, for example, key words, topics, metadata, website identifiers (e.g., Universal Resource Locators (URLs)), hyperlinks, and/or physical proximity or location.

In one embodiment, user activity data 105 and/or social network activity data 107 may be obtained by monitoring or observing one or more of the following:

a. Internet search engine key words;

b. web site visitations (e.g., key words from visited web sites, web site URLs, etc.);

c. membership in social networks (e.g., MySpace, Facebook, LinkedIn, etc.), forums (e.g., FlyerTalk, Photography On The Network, etc.), special interest community websites (e.g., igougo, etc.) and participation in subgroups or subtopics within membership-oriented websites;

d. other communications' content key words such as used in email, text messaging (e.g., short message service (SMS), multimedia message service (MMS), instant messaging (IM)), voice communications, and video communications;

e. information regarding purchases made by the user and/or members of the social network; or

f. close geographic proximity of two or more members of a social network.

In one embodiment, the activity of the user is one or more phone calls made by the user. The user's speech is monitored during the phone calls, and then the speech is converted to text. User activity data 105 includes information derived from this text.

In another embodiment, the activity of the user is one or more phone calls made by the user. User activity data 105 includes information obtained from call history logs for the user's phone calls. User activity data 105 includes information obtained or derived from the call history logs.

In another embodiment, the activity of the at least two members of the social network includes one or more phone calls by the at least two members. Social network activity data 107 includes information obtained or derived from call history logs for the at least two members.

In one embodiment, the social network activity data 107 for at least two members of the social network includes activity associated with a product, and the initiated action includes presenting an advertisement for the product to the user.

In another embodiment, the psycho-demographic data 117 includes data from transactions for at least two persons for a given product. Social network activity data 107 for at least two members of the social network includes purchase activity associated with the product, and the initiated action includes presenting information about the product to the user.

In various embodiments, server 101 may maintain, on a per user basis, and/or on an aggregate basis, the user data 115 and social data 119 using one or more methods of data handling, including the following:

a. a centralized approach (e.g., that may involve a central network data repository, using a new repository optimized for the embodiment, or using an existing repository that may or may not be enhanced for this new functionality such as, e.g., the Home Subscriber Server or Home Location Register of existing telecommunication systems);

b. a distributed approach; or

c. a hybrid approach.

In one embodiment, server 101 may function in a completely automated fashion, without input from the user, or with input from the user as part of the initialization process or as part of an ongoing refinement process.

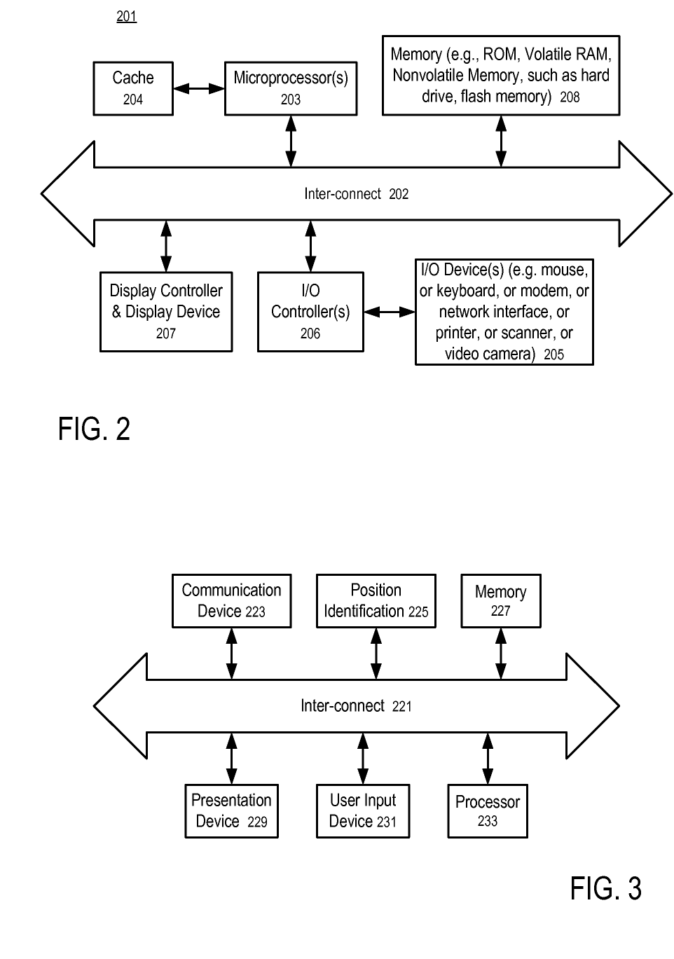

FIG. 2 shows a block diagram of a data processing system 201 which can be used in various embodiments. For example, system 201 may be used for providing server 101. While FIG. 2 illustrates various components of a computer system, it is not intended to represent any particular architecture or manner of interconnecting the components. Other systems that have fewer or more components may also be used.

In FIG. 2, the system 201 includes an inter-connect 202 (e.g., bus and system core logic), which interconnects a microprocessor(s) 203 and memory 208. The microprocessor 203 is coupled to cache memory 204 in the example of FIG. 2.

The inter-connect 202 interconnects the microprocessor(s) 203 and the memory 208 together and also interconnects them to a display controller and display device 207 and to peripheral devices such as input/output (I/O) devices 205 through an input/output controller(s) 206. Typical I/O devices include mice, keyboards, modems, network interfaces, printers, scanners, video cameras and other devices which are well known in the art.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

The memory 208 may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 2 is used to implement online social network site 123, and/or other servers, such as server 101.

In one embodiment, a data processing system as illustrated in FIG. 2 is used to implement a user device 141, etc. User device 141 may be in the form, for example, of a personal digital assistant (PDA), a cellular phone, a notebook computer or a personal desktop computer.

In some embodiments, one or more servers of the system can be replaced with the service of a peer to peer network of a plurality of data processing systems, or a network of distributed computing systems. The peer to peer network, or a distributed computing system, can be collectively viewed as a server data processing system.

Embodiments of the disclosure can be implemented via the microprocessor(s) 203 and/or the memory 208. For example, the functionalities described can be partially implemented via hardware logic in the microprocessor(s) 203 and partially using the instructions stored in the memory 208. Some embodiments are implemented using the microprocessor(s) 203 without additional instructions stored in the memory 208. Some embodiments are implemented using the instructions stored in the memory 208 for execution by one or more general purpose microprocessor(s) 203. Thus, the disclosure is not limited to a specific configuration of hardware and/or software.

FIG. 3 shows a block diagram of a user device 141 according to one embodiment. In FIG. 3, the user device 141 includes an inter-connect 221 connecting the presentation device 229, user input device 231, a processor 233, a memory 227, a position identification unit 225 and a communication device 223.

In FIG. 3, the position identification unit 225 is used to identify a geographic location of the user. The position identification unit 225 may include a satellite positioning system receiver, such as a Global Positioning System (GPS) receiver, to automatically identify the current position of the user device 141. In FIG. 3, the communication device 223 is configured to communicate with server 101.

In one embodiment, the user input device 231 is configured to generate user data content. The user input device 231 may include a text input device, a still image camera, a video camera, and/or a sound recorder, etc.

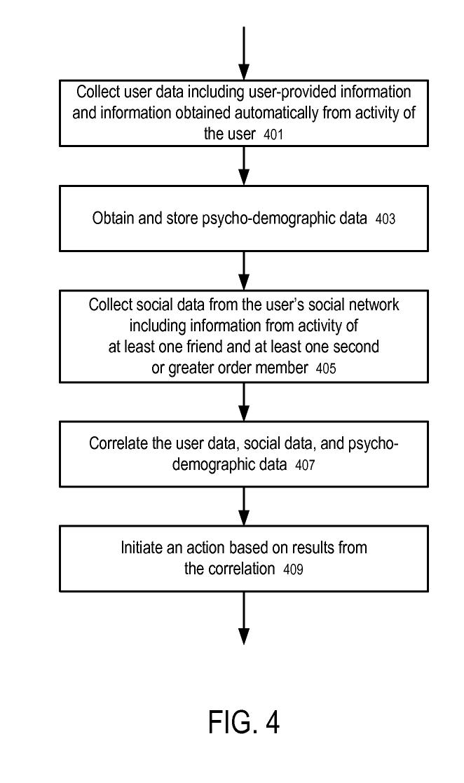

FIG. 4 shows a method to initiate an action based on data collected from a social network of a user according to one embodiment. In FIG. 4, server 101 collects user data 115 (401). The user data 115 includes user-provided information 129 and information obtained automatically from activity of the user (data 105).

In FIG. 4, psycho-demographic data 117 is obtained and stored (403) in database 103 (e.g., in one or more memories and/or database servers).

Social data 119 is collected from the social network (405). The social data 119 includes information obtained from activity of at least two members of the social network (data 107), in which the at least two members include at least one friend of the user and at least one second or greater order indirect member of the social network relative to the user.

The user data 115, the social data 119, and the psycho-demographic data 117 are correlated (407) (e.g., using at least one processor executing ranking module 113).

Server 101 initiates an action (409) based on the results of the correlation.

In one embodiment, the method of FIG. 4 further includes gathering mood information from the user's social network(s), and the initiating of the action is based in part on the mood information. In another embodiment, the user's mood information may further be gathered and considered as part of deciding whether to initiate an action. For example, server 101 may gather and render mood-related information, for the user and the user's social network (e.g., to reflect the degree to which each person is willing to communicate with others or to socially interact with others).

In one embodiment, geographic locations obtained from user devices 141-145 are stored in database 103. In one embodiment, information (e.g., product sales information, a map, etc.) is presented to the user. In one embodiment, a portion of the information presented is selected based on a set of preference criteria data 135 of the user.

One specific working, non-limiting hypothetical example of a use of the system above in one embodiment is described here, in which an application referred to as “LookOut” is executed on server 101 with respect to a user referred to as “Bob.”

Bob is provided by his communications service provider with a web-based application referred to as “LookOut.” Bob uses LookOut to see what's happening. Among other things, he learns about an interesting new illuminated Ultimate Frisbee disc. Unknown to Bob, several of his friends recently got Ultimate Frisbee discs and have started playing the game. Bob never thought about playing Frisbee before, but this is interesting to him, and he decides to get one and try it. Server 101 has provided Bob with personally interesting relevant information without prior recognition by user Bob that the information would be interesting (i.e., the user did not initiate a prior information request relevant to the topic).

Bob meets his friends for lunch. It's a presidential election year, and Bob and his friends are interested in the current political debates. LookOut enables Bob to stay current. Friend Bill says, “Hey, did you hear Obama has a new logo, Vero Possumus? Is that a possum thing?” Bob knows about it and laughs, “It means, Yes We Can. It's Latin dude.” Bob says he wants a T-shirt with an Obama supporter holding a possum, and the new logo on it. Server 101 has provided Bob with interesting current information relative to his interests.

Friend Sue asks, “Hey, anything going on this weekend?” From using LookOut, Bob knows about a band that sounds like it might be interesting, and is playing at a local pub. He's never heard of them before. When Bob tells his friends about the band he finds that several of his friends are fans of the band, and they'd all like to go to the performance. Bob discovers that he really likes the band, and it becomes one of his favorites, too. Server 101 has provided the user with interesting information relative to his friend's interests.

In the description above, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, implemented in a data processing system, for initiating an action based on data collected from a social network of a user, the method comprising:
collecting user data, wherein the user data comprises user-provided information and information obtained automatically from activity of the user;
storing, in at least one memory, psycho-demographic data;
collecting social data from the social network, wherein the social data comprises information obtained from activity of at least two members of the social network, the at least two members comprising at least one friend of the user and at least one second or greater order indirect member of the social network relative to the user;
correlating, using at least one processor, the user data, the social data, and the psycho-demographic data; and
initiating the action based on the correlating.

2. The method of claim 1, wherein the action comprises presenting, using a display, information to the user.

3. The method of claim 2, wherein:
the correlating comprises calculating a relative interest index for each of a plurality of information elements; and
the presenting information to the user comprises selecting at least one element, from the plurality of information elements, for display to the user based on the relative interest index for each of the plurality of information elements.

4. The method of claim 3, wherein the relative interest index is based on at least one of the following: the time duration of an activity, the frequency of an activity, the geographic location of a person or entity, and the timeliness of an activity.

5. The method of claim 1, wherein:
the activity of the user comprises a plurality of phone calls by the user;
the collecting user data comprises monitoring speech during the plurality of phone calls and converting the speech to text; and
the user data further comprises information from the text.

6. The method of claim 1, wherein:
the activity of the user comprises a plurality of phone calls by the user;
the collecting user data comprises obtaining information from call history logs for the plurality of phone calls by the user; and
the user data further comprises the information from the call history logs.

7. The method of claim 1 wherein:
the activity of the at least two members of the social network comprises a plurality of phone calls by the at least two members;
the collecting social data comprises obtaining information from call history logs for the plurality of phone calls by the at least two members; and
the social data further comprises the information from the call history logs for the at least two members.

8. The method of claim 1, further comprising:
gathering electronic data regarding at least one resource available to the user, wherein the at least one resource is selected from at least one of the following: a mobility resource, a communication resource, a device resource, and a calendar availability; and
wherein the initiating of the action is based in part on the electronic data regarding the at least one resource.

9. The method of claim 1, further comprising:
gathering mood information from the social network; and
wherein the initiating of the action is based in part on the mood information.

10. The method of claim 1, wherein the at least two members of the social network share at least one common relationship to the user data.

11. The method of claim 10, wherein the at least one common relationship comprises geographic proximity.

12. The method of claim 10, wherein the at least one common relationship comprises at least one of the following: a uniform resource locator, a contact name, a calendar date, an area code, and a text string.

13. The method of claim 1, wherein the social data comprises psycho-demographic information about the at least two members of the social network.

14. The method of claim 1, wherein the at least one second or greater order indirect member of the social network comprises two or more members of the social network having at least one item of psycho-demographic information in common.

15. The method of claim 1, wherein the information obtained automatically from activity of the user comprises at least one of the following: information regarding purchases made by the user, websites browsed by the user, and text from electronic communications of the user.

16. The method of claim 1, wherein:
the activity of the at least two members of the social network comprises activity associated with a product; and
the action comprises presenting an advertisement for the product to the user.

17. The method of claim 1, wherein the psycho-demographic data comprises data from electronic commerce transactions for a group having a size greater than ten thousand persons.

18. The method of claim 1, wherein the psycho-demographic data comprises data from search inquiries for a group having a size greater than ten thousand persons.

19. The method of claim 1, wherein:
the psycho-demographic data comprises data from transactions of at least two persons for a product;
the activity of the at least two members of the social network comprises purchase activity associated with the product; and
the action comprises presenting information about the product to the user.

20. A machine readable media embodying instructions, the instructions causing a data processing system to perform a method for initiating an action based on data collected from a social network of a user, the method comprising:
collecting user data, wherein the user data comprises user-provided information and information obtained automatically from activity of the user;
storing psycho-demographic data;
collecting social data from the social network, wherein the social data comprises information obtained from activity of at least two members of the social network, the at least two members comprising at least one friend of the user and at least one second or greater order indirect member of the social network relative to the user;
correlating the user data, the social data, and the psycho-demographic data; and
initiating the action based on the correlating.

21. A data processing system for initiating an action based on data collected from a social network of a user, the system comprising:
means for collecting user data, wherein the user data comprises user-provided information and information obtained automatically from activity of the user;
at least one memory to store psycho-demographic data;
means for collecting social data from the social network, wherein the social data comprises information obtained from activity of at least two members of the social network, the at least two members comprising at least one friend of the user and at least one second or greater order indirect member of the social network relative to the user;
at least one processor configured to correlate the user data, the social data, and the psycho-demographic data; and
means for initiating the action based on the correlating.
